(19) United States
(12) Patent Application Publication
(10) Pub. No.: US 2026/0133525 A1
(43) Pub. Date: May 14, 2026

(54) IMAGE FORMING APPARATUS

(71) Applicant: KYOCERA Document Solutions Inc., Osaka (JP)

(72) Inventors: Einosuke KIKUCHI, Osaka (JP); Akira MATAYOSHI, Osaka (JP)

(73) Assignee: KYOCERA Document Solutions Inc., Osaka (JP)

(21) Appl. No.: 19/381,486

(22) Filed: Nov. 6, 2025

(30) Foreign Application Priority Data
Nov. 11, 2024 (JP) 2024-196580

(51) Int. Cl. G03G 15/16; G03G 15/00; G03G 21/10

(52) U.S. Cl. CPC G03G 15/161; G03G 15/5054; G03G 21/10; G03G 2215/00059

(57) ABSTRACT

An image forming apparatus includes an image carrying member, a charging device, an exposure device, a developing device, an intermediate transfer belt, a cleaning brush, an image density sensor, and a control portion. The control portion is capable of executing a cleaning performance determination mode for determining cleaning performance of the cleaning brush. The cleaning performance determination mode includes: a reference image formation process of forming a reference image on the intermediate transfer belt; and a first bare-surface-measurement process of detecting a reference-image formation area, using the image density sensor, after the intermediate transfer belt has rotated once. When a fluctuation range of an output waveform of the image density sensor in the first bare surface measurement process is equal to or less than a threshold value, it is determined that the cleaning performance of the cleaning brush is normal.

### INCORPORATION BY REFERENCE

This application is based on and claims the benefit of priority from Japanese Patent Application No. 2024-196580 filed on November 11, 2024, the contents of which are hereby incorporated by reference.

### BACKGROUND

The present disclosure relates to an image forming apparatus employing an intermediate transfer method in which a cleaning brush is used to remove residual toner from the surface of an intermediate transfer belt.

Conventionally, there has been known an intermediate transfer type image forming apparatus including an intermediate transfer belt that is endless-shaped and driven to rotate in a predetermined direction and a plurality of image forming portions arranged along the intermediate transfer belt. In such an image forming apparatus, toner images of respective colors are primarily transferred by the image forming portions onto the intermediate transfer belt so as to be sequentially superimposed on each other, and then the toner images are secondarily transferred onto a recording medium.

In the intermediate transfer type image forming apparatus, in a case where the intermediate transfer belt has an elastic layer, a cleaning device is used which includes, arranged in its housing, a cleaning brush that mechanically and electrically collects toner remaining on the surface of the intermediate transfer belt, a collection roller that collects toner from the cleaning brush, a scraper that scrapes off toner from the surface of the collection roller, and a conveyance spiral that conveys toner scraped off from the surface of the collection roller into a waste toner collection container.

On the other hand, in the intermediate transfer type image forming apparatus, a calibration operation is executed to adjust image density or color shift by detecting the density of a reference image (patch image) transferred onto the intermediate transfer belt. At that time, if a defect such as a scratch or contamination has occurred on the intermediate transfer belt, it may prevent the calibration operation from accurately adjusting image density or color shift.

### SUMMARY

According to one aspect of the present disclosure, an image forming apparatus includes an image carrying member, a charging device, an exposure device, a developing device, an intermediate transfer belt, a cleaning brush, an image density sensor, and a control portion. The image carrying member includes a photosensitive layer formed on a surface thereof. The charging device charges the surface of the image carrying member. The exposure device exposes, to light, the surface of the image carrying member having been charged by the charging device, thereby forming an electrostatic latent image with attenuated charge. The developing device includes a developer carrying member carrying a developer including toner, and develops the electrostatic latent image having been formed on the image carrying member into a toner image. The intermediate transfer belt, having an endless shape, rotates in contact with the image carrying member, thereby having the toner image primarily transferred thereto. The cleaning brush removes toner remaining on the intermediate transfer belt. The image density sensor detects density of the toner image having been primarily transferred onto the intermediate transfer belt. The control portion is capable of executing a cleaning performance determination mode for determining cleaning performance of the cleaning brush. The cleaning performance determination mode includes: a reference image formation process of forming a reference image on the intermediate transfer belt; and a first bare-surface-measurement process of detecting a reference-image formation area, using the image density sensor, after the intermediate transfer belt has rotated once. When a fluctuation range of an output waveform of the image density sensor in the first bare-surface-measurement process is equal to or less than a threshold value, it is determined that the cleaning performance of the cleaning brush is normal.

### BRIEF DESCRIPTION OF THE DRAWINGS

FIG. 1 is a schematic view showing an inner configuration of an image forming apparatus according to one embodiment of the present disclosure.

FIG. 2 is a side sectional view showing a configuration around an intermediate transfer unit 30 incorporated in the image forming apparatus.

FIG. 3 is an enlarged view around an image forming portion in FIG. 2.

FIG. 4 is a block diagram showing one example of a control path in the image forming apparatus.

FIG. 5 is a schematic diagram showing an example of calibration executed in the image forming apparatus.

FIG. 6 is a schematic diagram showing another example of calibration executed in the image forming apparatus.

FIG. 7 is a graph showing detection results of an image density sensor when the cleaning performance of a cleaning brush is normal.

FIG. 8 is a graph showing detection results of the image density sensor when the cleaning performance of the cleaning brush has deteriorated.

FIG. 9 is a graph showing detection results of the image density sensor obtained when an intermediate transfer belt has been rotated once more from the state shown in FIG. 8.

FIG. 10 is a flowchart showing an example of controlling a cleaning performance determination mode executed in the image forming apparatus.

FIG. 11 is a flowchart showing an example of controlling operational-life determination for the cleaning brush and changing of a cleaning condition when it is determined that the cleaning performance of the cleaning brush has deteriorated.

### DETAILED DESCRIPTION

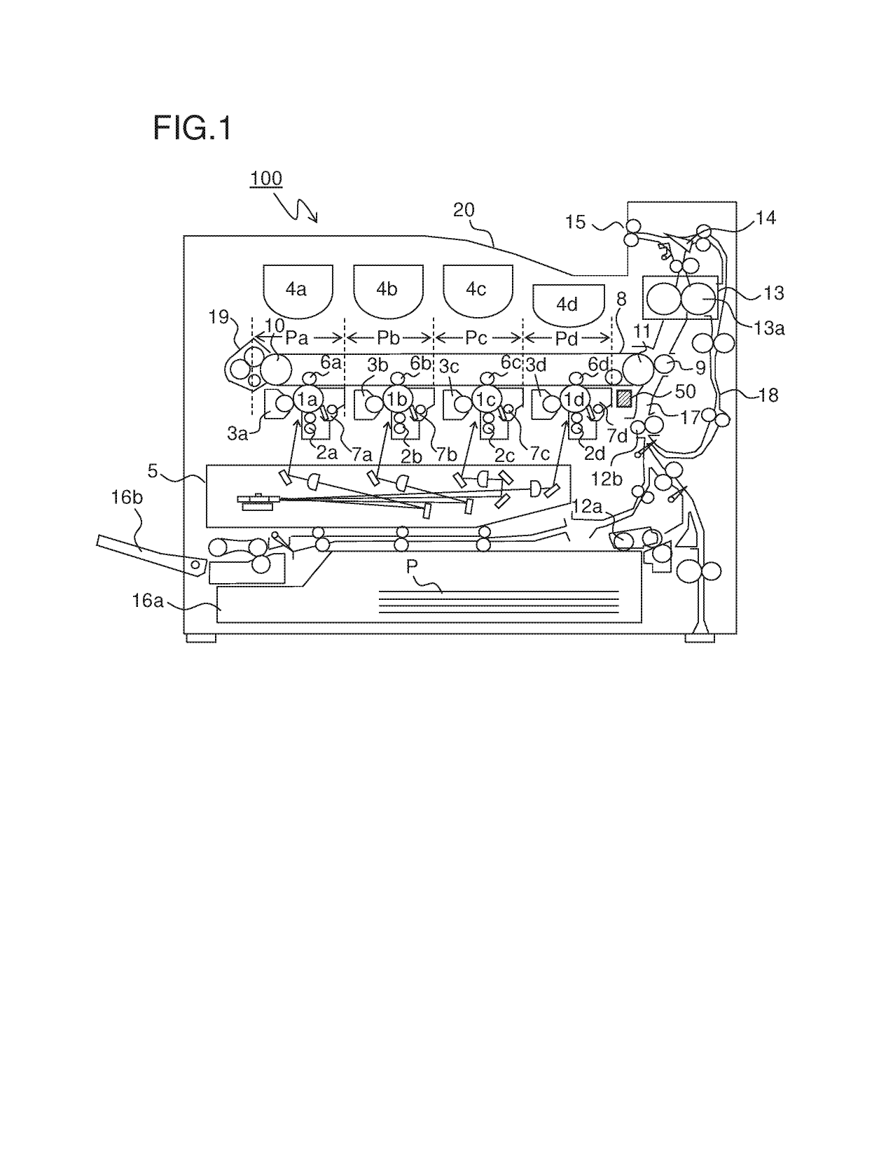

Hereinafter, an embodiment of the present disclosure will be described with reference to the accompanying drawings. FIG. 1 is a schematic view showing a configuration of an image forming apparatus 100 according to one embodiment of the present disclosure. Herein, a so-called tandem-type color printer is exemplified as the image forming apparatus 100.

In the main body of the image forming apparatus 100, four image forming portions Pa, Pb, Pc, and Pd are arranged in order from an upstream side (right side in FIG. 1) in a conveyance direction. These image forming portions Pa to Pd respectively include, arranged therein, photosensitive drums 1a, 1b, 1c, and 1d that each carry an image of a corresponding one of four different colors (cyan, magenta, yellow, and black), and sequentially form cyan, magenta, yellow, and black images through processes of charging, exposure, development, and transfer. Further, an intermediate transfer belt 8, which rotates in the counterclockwise direction in FIG. 1, is arranged adjacent to the photosensitive drums 1a to 1d.

Next, the image forming portions Pa to Pd will be described. Around the photosensitive drums 1a to 1d, along a drum rotation direction (the clockwise direction in FIG. 1), charging devices 2a to 2d, developing devices 3a to 3d, and cleaning devices 7a to 7d are arranged, respectively, and further, primary transfer rollers 6a to 6d are arranged facing the photosensitive drums 1a to 1d, respectively, with the intermediate transfer belt 8 therebetween. Further, on an upstream side of the photosensitive drum 1a in a rotation direction of the intermediate transfer belt 8, a belt cleaning unit 19 is disposed opposite a tension roller 10 with the intermediate transfer belt 8 therebetween.

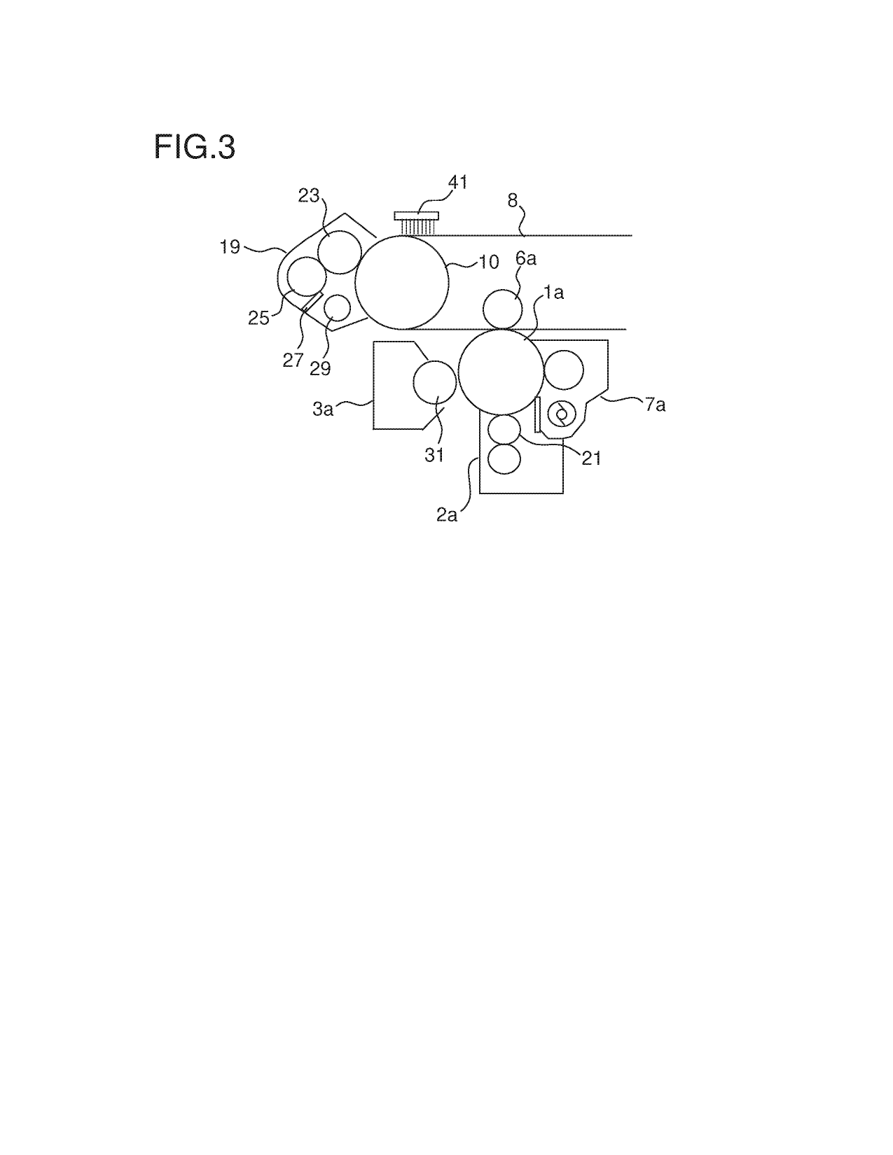

Next, a description will be given of an image forming procedure in the image forming apparatus 100. When image data is fed from a host device such as a personal computer, first, the charging devices 2a to 2d uniformly charge surfaces of the photosensitive drums 1a to 1d, respectively. Subsequently, the exposure device 5 executes light irradiation based on the image data, thereby forming electrostatic latent images on the photosensitive drums 1a to 1d based on the image data. The developing devices 3a to 3d are each loaded with a predetermined amount of a corresponding one of two-component developers (hereinafter simply referred to as developers) replenished from toner containers 4a to 4d, respectively, the developers each including toner of a corresponding one of the four colors, namely, cyan, magenta, yellow, and black. The developing devices 3a to 3d each include a developing roller 31 (see FIG. 3) that carries the developer thereon.

By the developing roller 31, toner included in the developer is supplied onto, and electrostatically adheres to, each of the photosensitive drums 1a to 1d. Thereby, toner images are formed corresponding to the electrostatic latent images having been formed through the exposure by the exposure device 5.

Then, by the primary transfer rollers 6a to 6d, an electric field is applied at a predetermined transfer voltage between the primary transfer rollers 6a to 6d and the photosensitive drums 1a to 1d, respectively, and thereby, the cyan, magenta, yellow, and black toner images respectively on the photosensitive drums 1a to 1d are primarily transferred onto the intermediate transfer belt 8. Toner and other substances remaining on the surfaces of the photosensitive drums 1a to 1d after the primary transfer are removed by the cleaning devices 7a to 7d, respectively.

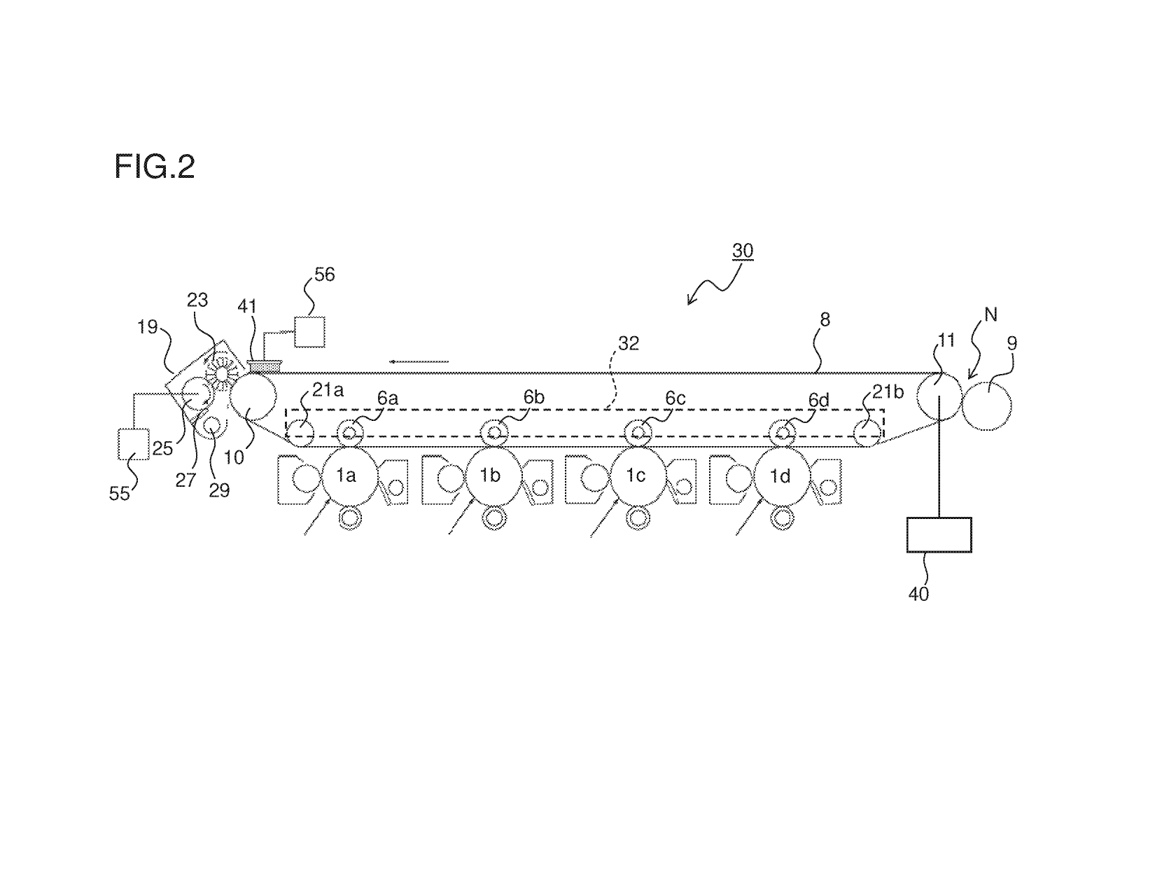

A transfer sheet P, onto which the toner images are to be transferred, is stored inside a sheet cassette 16a disposed at a lower part inside the image forming apparatus 100, or put on a manual feed tray 16b disposed on a side face of the image forming apparatus 100. The transfer sheet P, in the sheet cassette 16a or on the manual feed tray 16b, are sent out by a sheet feed roller 12a into a sheet conveyance path 17. The transfer sheet P is conveyed by a registration roller pair 12b, with predetermined timing, to a nip portion (secondary transfer nip portion N, see FIG. 2) between a secondary transfer roller 9, which is arranged adjacent to the intermediate transfer belt 8, and the intermediate transfer belt 8. After the toner images are secondarily transferred onto the transfer sheet P, the transfer sheet P is conveyed to a fixing portion 13. Toner and other substances remaining on the surface of the intermediate transfer belt 8 are removed by the belt cleaning unit 19.

After being conveyed to the fixing portion 13, the transfer sheet P is heated and pressed by a fixing roller pair 13a, and thereby the toner images are fixed onto the surface thereof to form a predetermined full-color image. After the full-color image is formed thereon, the transfer sheet P is discharged from the sheet conveyance path 17 onto a discharge tray 20 via a discharge roller pair 15 as it is (or after being delivered into a reverse conveyance path 18 by a branching portion 14 to have images formed on both sides thereof).

At a position opposite the drive roller 11 across the intermediate transfer belt 8, an image density sensor 50 is disposed. Typically used as the image density sensor 50 is an optical sensor that includes a light emitting element constituted of an LED or the like and a light receiving element constituted of a photodiode or the like. To measure a toner adhesion amount on the intermediate transfer belt 8, patch images (reference images) formed on the intermediate transfer belt 8 are irradiated with measurement light from the light emitting element, so that the measurement light enters the light-receiving element as light reflected by the toner and light reflected by the belt surface.

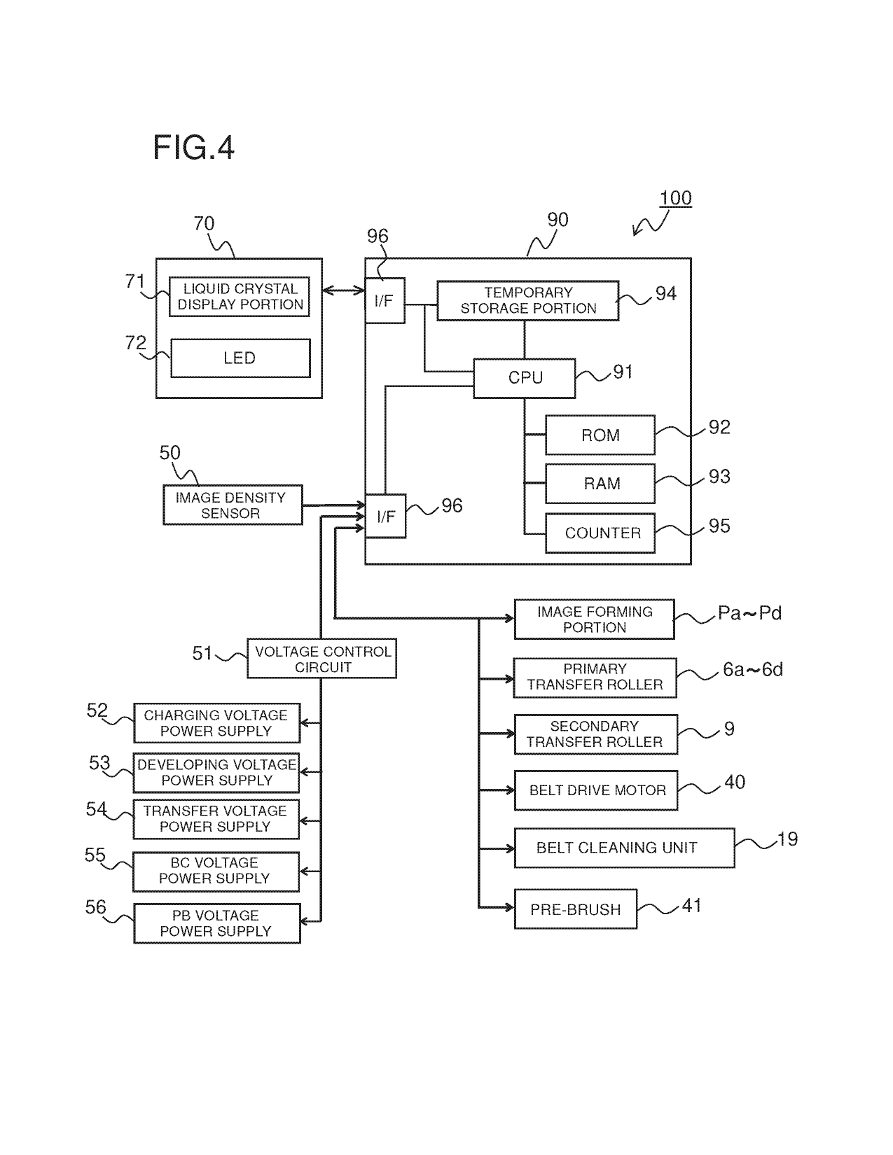

The light reflected from the toner and the belt surface includes specular reflection light and diffused reflection light. The specular reflection light and the diffused reflection light are separated through a polarization splitting prism and then enter separate light receiving elements. Each of the light receiving elements performs photoelectric conversion on the received specular or diffused reflection light and outputs an output signal to a control portion 90 (see FIG. 4).

Then, image densities (toner amounts) and positions of the patch images are detected based on change in characteristics of the output signals of the specular reflection light and the diffused reflection light, and they are compared with a predetermined reference density and a predetermined reference position, so as to adjust a characteristic value of development voltage, exposure starting position and timing of the exposure device 5, etc. In this manner, image density correction and color shift correction (calibration) are performed for each color.

FIG. 2 is a side sectional view showing a configuration around an intermediate transfer unit 30 incorporated in the image forming apparatus 100. FIG. 3 is an enlarged view around the image forming portion Pa in FIG. 2. The intermediate transfer unit 30 includes the intermediate transfer belt 8 stretched between a tension roller 10 disposed on the upstream side and the drive roller 11 disposed on the downstream side, the primary transfer rollers 6a to 6d that are in contact with the photosensitive drums 1a to 1d via the intermediate transfer belt 8, backup rollers 21a and 21b, the belt cleaning unit 19, a pre-brush 41, and a roller contact/separation mechanism 32. To the drive roller 11, a belt drive motor 40 is connected via a gear train (unillustrated).

The intermediate transfer belt 8 is an elastic rubber belt including an elastic layer laid on the surface of a base layer thereof. By providing the elastic layer, it is possible to prevent a dropout phenomenon caused in an image by stress concentration during the secondary transfer. Used as a material of the base layer is, for example, a polyimide resin, a PVDF (polyvinylidene difluoride) resin, or the like mixed with a conductive material such as an ion conductive material, a conductive carbon, etc., for conductivity. Used as a material of the elastic layer is, for example, a hydrin rubber, a chloroprene rubber, a polyurethane rubber, etc. A coat layer may further be provided to protect the elastic layer. Used as a material of the coat layer is an acrylic resin, a silicone resin, a fluororesin, etc.

The belt cleaning unit 19 includes, arranged in a housing thereof, the cleaning brush 23, a collection roller 25, a scraper 27, and a conveyance spiral 29. The cleaning brush 23 is disposed opposite the tension roller 10 with the intermediate transfer belt 8 therebetween. The cleaning brush 23 rotates in a direction (counterclockwise direction in FIG. 2) opposite to the movement direction of the intermediate transfer belt 8, thereby removing foreign matters, such as toner particles, carrier particles, paper powder, etc., remaining on the intermediate transfer belt 8.

The cleaning brush 23 includes a brush portion that contacts the collection roller 25, and the brush portion is formed of conductive fiber having an electrical resistance on the order of 1 to 900 MΩ.

The collection roller 25 rotates in contact with a surface of the cleaning brush 23 in a direction (clockwise direction in FIG. 2) opposite to the direction in which the cleaning brush 23 rotates, thereby collecting toner and other substances adhered on the cleaning brush 23. To the collection roller 25, a belt-cleaning voltage power supply 55 is connected to apply the collection roller 25 a cleaning voltage during the cleaning of the intermediate transfer belt 8. The cleaning voltage is a direct-current voltage having a polarity opposite to the normal charge polarity of the toner (hereinafter referred to as having a polarity opposite to that of the toner).

Specifically, since the toner used in the present embodiment is positively chargeable, the cleaning voltage applied is negative in polarity. Further, the tension roller 10 is grounded (earthed). As a result, toner and other substances having been removed from the intermediate transfer belt 8 are electrically and mechanically collected by the brush portion of the cleaning brush 23 and further caused to electrically move to the collection roller 25. The conveyance spiral 29 conveys the toner and other substances, having been scraped off from the collection roller 25 by the scraper 27, into an externally provided waste toner collection container (not shown).

The pre-brush 41 is disposed upstream of the belt cleaning unit 19 with respect to the movement direction of the intermediate transfer belt 8. To the pre-brush 41, a pre-brush voltage power supply 56 is connected, which applies, to the pre-brush 41, a pre-brush voltage (pre-cleaning voltage), which is a direct-current voltage having the same polarity as the toner charge polarity (hereinafter referred to as having the same polarity as the toner), thereby uniformizing the residual toner charge amount on the intermediate transfer belt 8. Since the toner used in the present embodiment is positively chargeable, the pre-brush voltage applied is positive in polarity. This helps the cleaning brush 23 to easily remove the residual toner on the intermediate transfer belt 8.

The pre-brush 41 is preferably formed of a material having a lower position in the triboelectric series as compared to the elastic layer of the intermediate transfer belt 8. The triboelectric series is a ranking of substances based on their tendency to become electrically charged when rubbed against each other. Substances that tend to acquire a positive (+) charge are placed higher in the series, while those that tend to acquire a negative (−) charge are placed lower.

The charge polarity of a substance changes depending on the material it is rubbed against. When two materials from different positions in the triboelectric series are rubbed together, the material higher in the series becomes positively charged, while the one lower in the series becomes negatively charged. In the present embodiment, through friction with the intermediate transfer belt 8, the pre-brush 41 acquires an electric charge with a polarity (here, negative polarity) opposite to that of the toner (here, positive polarity). Examples of the material for the pre-brush 41 described above include polyester and acrylics, for example.

The roller contact/separation mechanism 32 is capable of switching between a plurality of operational modes including: a color mode, in which the four primary transfer rollers 6a to 6d are respectively pressed against the photosensitive drums 1a to 1d via the intermediate transfer belt 8; a monochrome mode, in which only the primary transfer roller 6d is pressed against the photosensitive drum 1d via the intermediate transfer belt 8, and a primary transfer release state, in which the four primary transfer rollers 6a to 6d are all separated from the intermediate transfer belt 8.

FIG. 4 is a block diagram showing one example of a control path used in the image forming apparatus 100. Note that the image forming apparatus 100 is used with various controls executed on its various portions, which results in a complex control path of the entire image forming apparatus 100. Hence, the description here will focus on necessary part of the control path for implementation of the present disclosure.

The control portion 90 at least includes a CPU (central processing unit) 91 as a central processor, a ROM (read only memory) 92 which is a read-only storage portion, a RAM (random access memory) 93 which is a readable/writable storage portion, a temporary storage portion 94 that temporarily stores image data and the like, a counter 95, and a plurality of (here, two) I/Fs (interfaces) 96, which each transmit a control signal to various devices in the image forming apparatus 100 and receive an input signal from the operation portion 70. Further, the control portion 90 can be disposed anywhere inside the main body of the image forming apparatus 100.

The ROM 92 stores a control program for the image forming apparatus 100, data that stays unchanged during use of the image forming apparatus 100, such as numerical values necessary for controlling the image forming apparatus 100, etc. The RAM 93 stores necessary data generated during control of the image forming apparatus 100, data temporarily required for controlling the image forming apparatus 100, etc. Examples of the data stored in the RAM 93 include the relationship between output values of the image density sensor 50 and image forming conditions during the execution of calibration as described later, a threshold value for output values of the image density sensor 50 during a cleaning performance determination mode, etc. The counter 95 counts the number of printed sheets in a cumulative manner.

Further, the control portion 90 transmits control signals, from the CPU 91 through the I/Fs 96, to various portions and devices in the image forming apparatus 100. Further, from various portions and devices, signals indicating their conditions or input signals are transmitted to the CPU 91 through the I/Fs 96. Various portions and devices controlled by the control portion 90 include the image forming portions Pa to Pd, the exposure device 5, the primary transfer rollers 6a to 6d, the secondary transfer roller 9, the image density sensor 50, a voltage control circuit 51, the operation portion 70, etc.

The voltage control circuit 51 is connected to a charging voltage power supply 52, a development voltage power supply 53, a transfer voltage power supply 54, the belt-cleaning voltage power supply 55, and the pre-brush voltage power supply 56, and causes these power supplies to operate in response to output signals from the control portion 90. Specifically, in response to a control signal from the voltage control circuit 51, the charging voltage power supply 52 applies a predetermined charging voltage to charging rollers 21 provided inside the charging devices 2a to 2d. The development voltage power supply 53 applies a predetermined development voltage to developing rollers 31 provided inside the developing devices 3a to 3d. The transfer voltage power supply 54 applies a predetermined primary transfer voltage to the primary transfer rollers 6a to 6d and a predetermined secondary transfer voltage to the drive roller 11. The belt-cleaning voltage power supply 55 applies a predetermined cleaning voltage to the collection roller 25 of the belt cleaning unit 19. The pre-brush voltage power supply 56 applies a predetermined pre-brush voltage to the pre-brush 41. Note that, here, a secondary transfer voltage having the same polarity as the toner is applied to the drive roller 11 opposite the secondary transfer roller 9, but instead, a secondary transfer voltage having a polarity opposite to that of the toner may be applied to the secondary transfer roller 9.

The operation portion 70 includes a liquid crystal display portion 71 and LEDs 72 that indicate various states. A user operates a stop/clear button of the operation portion 70 to stop image formation, and operates a reset button to reset various settings of the image forming apparatus 100 to their default states. The liquid crystal display portion 71 is configured to indicate the condition of the image forming apparatus 100, the progress of image formation, and the number of printed copies. Various settings of the image forming apparatus 100 are made via a printer driver on a personal computer.

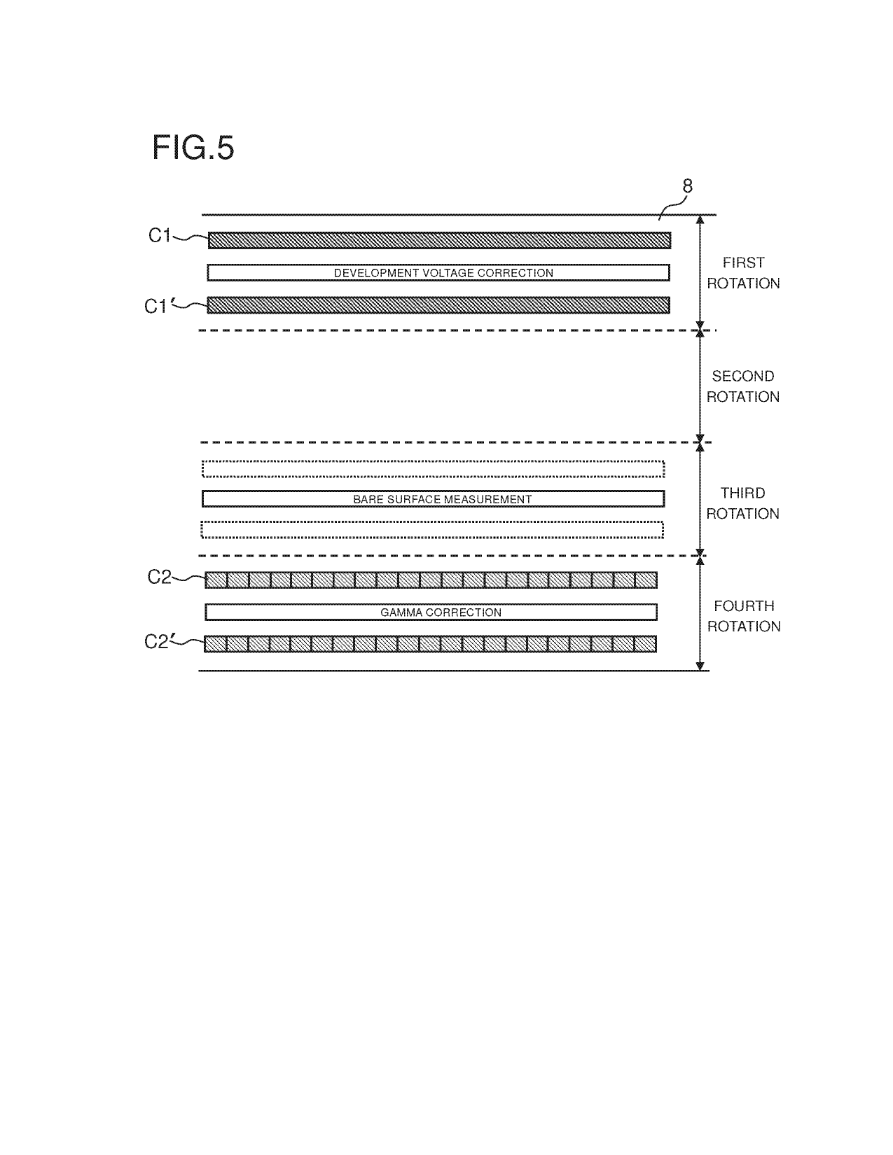

FIG. 5 is a schematic diagram showing an example of calibration executed in the image forming apparatus 100. As shown in FIG. 5, during a first rotation of the intermediate transfer belt 8, a reference image C1 (first reference image) for development voltage correction is formed. The reference image C1 includes a cyan solid image. The image density sensor 50 detects the image density of the reference image C1, and based on the detection result, the development voltage applied to the developing roller 31 of the developing device 3a for cyan is corrected. Subsequently, a reference image C1′ (first reference image) after the correction of the development voltage is formed, the image density sensor 50 detects the image density of the reference image C1′, and it is determined whether the image density (amount of toner developed) has reached a target value.

During a second rotation of the intermediate transfer belt 8, no reference image is formed, and only cleaning of the reference images C1 and C1′ is executed by the belt cleaning unit 19.

During a third rotation of the intermediate transfer belt 8, the image density sensor 50 detects the surface condition of the area on the intermediate transfer belt 8 where the reference images C1 and C1′ were formed (bare surface measurement), and it is determined whether the reference images C1 and C1′ have been collected by the belt cleaning unit 19.

During a fourth rotation of the intermediate transfer belt 8, a reference image C2 (second reference image) for correction (gamma correction) of gradation input value (exposure amount setting value) is formed. The reference image C2 includes patch images with a plurality of density levels, from the lightest to the darkest. Adjacent ones of the patch images are formed monochromatic such that their densities change at the boundary between them.

The image density sensor 50 detects image densities of the reference image C2, and based on the detection result, the gradation input value (exposure amount setting value) is corrected.

Specifically, toner adhesion amounts (toner densities) of the patch images are detected by the image density sensor 50 and are compared with predetermined target densities, and then an average value of density differences between the toner densities and the target densities is calculated. In accordance with the obtained average value of the density differences, a parameter value used for gradation correction is determined, and gradation correction is executed with respect to each density. Subsequently, a reference image C2′ (second reference image) after the correction of the gradation input value is formed, the image density sensor 50 detects the image densities of the reference image C2′, and it is determined whether the image density of each patch image has reached a target value.

In the development voltage correction, for the purpose of determining the maximum value of the developed toner amount, as the reference images C1 and C1′, solid images with large amounts of toner are formed on the intermediate transfer belt 8. As a result, with a brush cleaning method using the cleaning brush 23, it is not easy to collect the reference images C1 and C1′ all at once after the measurement of image densities.

To address this inconvenience, in the example shown in FIG. 5, after the execution of development voltage correction, the intermediate transfer belt 8 is rotated twice to collect the reference images C1 and C1′ separately during the two rotations. This makes it possible, even under the condition where the collection performance of the cleaning brush 23 has deteriorated, to prevent the reference images C1 and C1′ from affecting bare surface measurement performed prior to the execution of gamma correction.

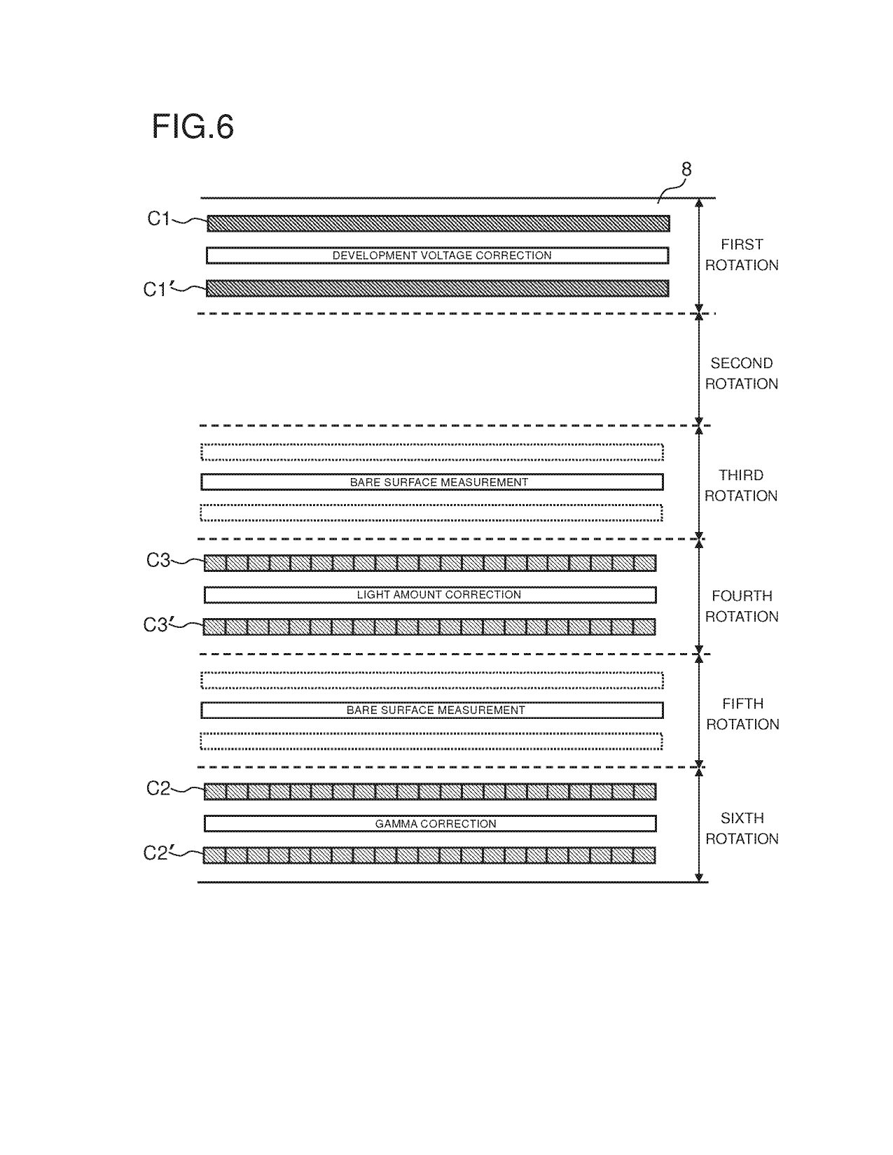

In the example shown in FIG. 5, the gradation input value is corrected after the development voltage is corrected, but the following method may be adopted, in which, as shown in FIG. 6, after the development voltage is corrected, reference images C3 and C3′ (second reference images) are formed to execute light amount correction to determine the light amount of laser light (laser power) of the exposure device 5, and after the execution of light amount correction, the reference images C2 and C2′ are formed to execute gradation input value correction. In the example shown in FIG. 6, after the execution of development voltage correction, the intermediate transfer belt 8 is rotated twice, and bare surface measurement is performed before light amount correction and gradation input value correction are executed.

The above description, which has dealt with calibration for cyan, is equally applicable to magenta, yellow, and black. Specifically, reference images M1, M1′, Y1, Y1′, K1, and K1′are formed to perform development voltage correction. Further, reference images M2, M2′, Y2, Y2′ K2, and K2′ are formed to perform gamma correction. Furthermore, reference images M3, M3′, Y3, Y3′, K3, and K3′ are formed to perform light amount correction.

Note that, in a case where the cleaning performance of the cleaning brush 23 has deteriorated more than expected, even if the intermediate transfer belt 8 is rotated twice to collect the reference images C1 and C1′ to K1 and K1′ separately during the two rotations, a small amount of toner may remain on the intermediate transfer belt 8, which may affect bare surface measurement. In a case where no threshold value is provided in bare surface measurement, the bare surface detected includes noise attributable to the residual toner, which may prevent appropriate execution of gamma correction or light amount correction after the bare surface measurement.

In a case where a threshold value is provided in bare surface measurement, the surface condition of the intermediate transfer belt 8 can be measured accurately, but in a case where the surface condition of the intermediate transfer belt 8 is not normal, calibration cannot be executed.

For example, in a case where scratches or irregularities are present on the surface of the intermediate transfer belt 8, calibration may be stopped due to detection of an abnormality. On the other hand, in a case where the cleaning performance of the cleaning brush 23 has deteriorated, allowing residual toner to remain, a malfunction is caused in which calibration fails to be executed even though the surface condition of the intermediate transfer belt 8 is normal.

To prevent such a malfunction, the present embodiment is configured to execute the cleaning performance determination mode for detecting the surface condition of the intermediate transfer belt 8 to determine the cleaning performance of the cleaning brush 23 based on the detection result. Specifically, a reference image for cleaning performance detection is formed on the intermediate transfer belt 8 (a reference image formation process). Subsequently, the intermediate transfer belt 8 is caused to rotate once, and after the reference image has passed the cleaning brush 23, the formation area of the reference image is detected by the image density sensor 50 (a first bare-surface-measurement process).

The cleaning performance determination mode may be executed each time the cumulative number of printed sheets reaches a predetermined number, or may be executed in a case where an error has occurred during calibration.

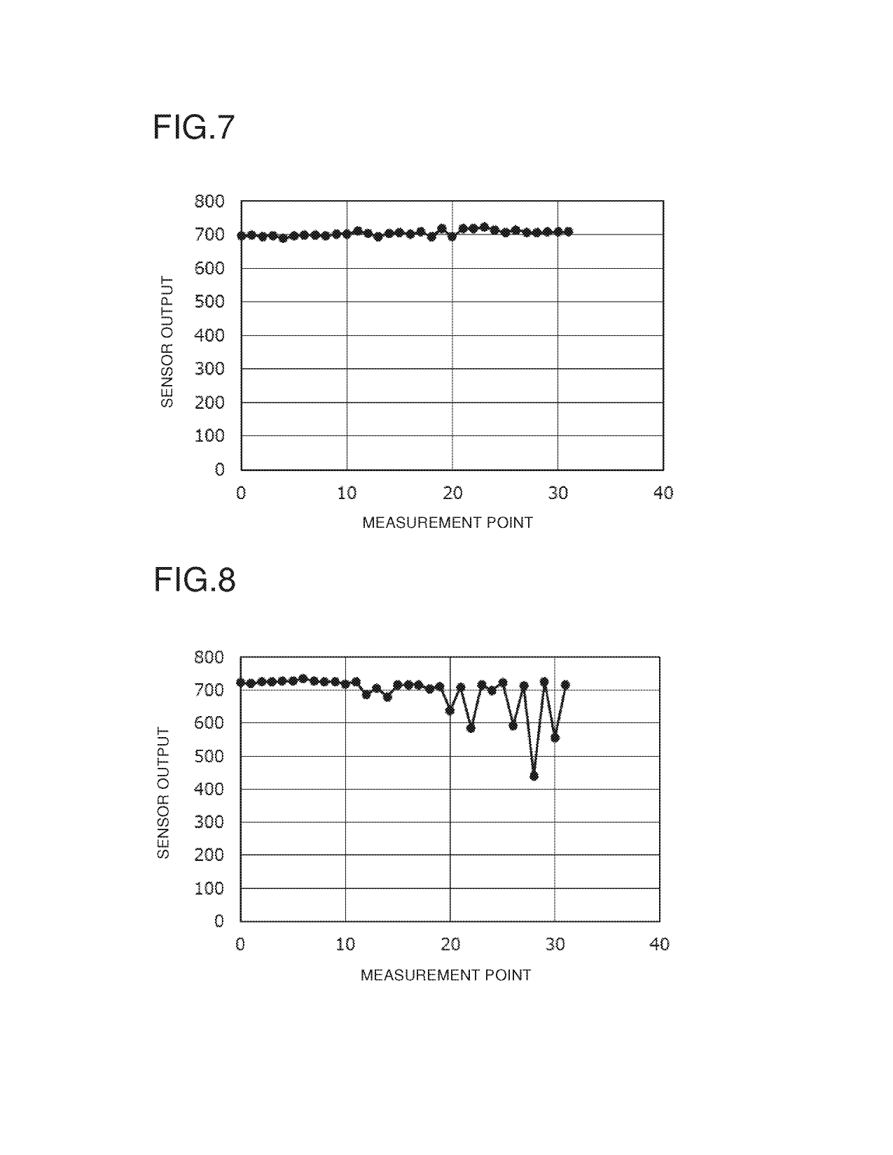

FIG. 7 is a graph showing detection results of the image density sensor 50 when the cleaning performance of a cleaning brush 23 is normal. When the performance of the cleaning brush 23 is normal, by causing the intermediate transfer belt 8 to rotate once, the reference image can be completely collected. Thus, it can be confirmed that the output waveform of the image density sensor 50 is stable.

FIG. 8 is a graph showing detection results of the image density sensor 50 when the cleaning performance of the cleaning brush 23 has deteriorated. When the performance of the cleaning brush 23 has deteriorated, even by causing the intermediate transfer belt 8 to rotate once, the reference image cannot be completely collected. As a result, peaks appear in the output waveform of the image density sensor 50 due to the influence of residual toner.

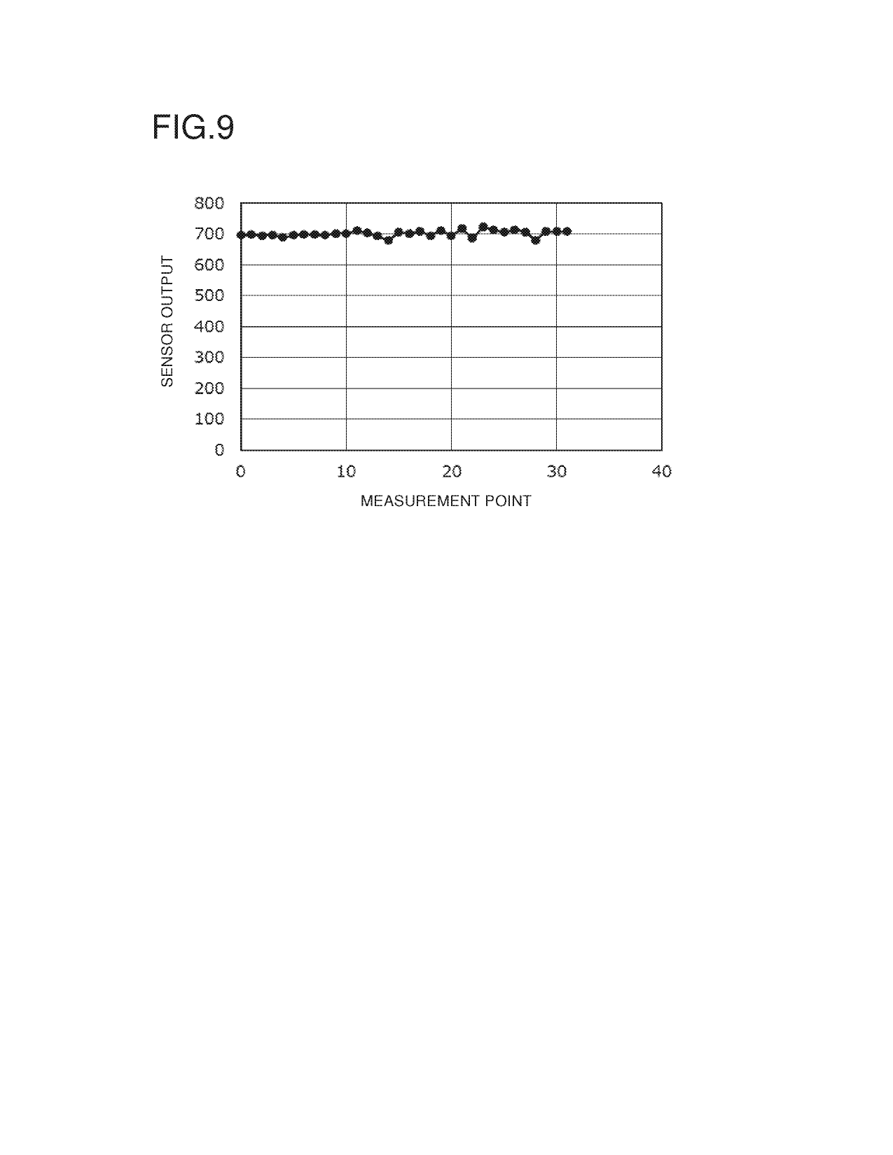

FIG. 9 is a graph showing detection results of the image density sensor 50 obtained when the intermediate transfer belt 8 has been rotated once more from the state shown in FIG. 8.

In a case where, as a result of causing the intermediate transfer belt 8 to rotate once more and executing bare surface measurement (a second bare-surface-measurement process), it is confirmed that the output waveform is stable as shown in FIG. 9, it can be determined that no scratches or irregularities have occurred on the surface of the intermediate transfer belt 8, and that the instability of the output waveform is due to deterioration in the performance of the cleaning brush 23.

Further, in a case where the bare surface measurement performed during the additional rotation of the intermediate transfer belt 8 has resulted in detection of an abnormality as in the previous rotation (FIG. 8), it can be determined that scratches, irregularities, or the like have occurred on the surface of the intermediate transfer belt 8.

A major factor contributing to deterioration in cleaning performance of the cleaning brush 23 is the deterioration of the cleaning brush 23 itself, in particular, outer diameter variation caused by bristle bending. When it is determined that the cleaning performance of the cleaning brush 23 has deteriorated, the durability of the cleaning brush 23 is checked. Specifically, the drive torque and the drive time of the cleaning brush 23 are detected. In a case where the drive torque has changed by a certain amount or more since initial use and the drive time has exceeded certain duration, it can be determined that the cleaning brush 23 has deteriorated.

Moreover, surface properties of the intermediate transfer belt 8 also affect the cleaning performance of the cleaning brush 23. Taking this into consideration, in a case where, based on a drive time of the intermediate transfer belt 8 and a surface glossiness degree of the intermediate transfer belt 8 calculated from the detection value of the image density sensor 50, the durability (the degree of deterioration) of the intermediate transfer belt 8 is estimated to be a certain degree or more, it is comprehensively determined that the cleaning performance of the cleaning brush 23 has deteriorated and the cleaning brush 23 has reached the end of its operational life.

On the other hand, in a case where the cleaning brush 23 itself and the intermediate transfer belt 8 have not significantly deteriorated, the toner amount and the toner charge amount of the reference image are detected. Then, in a case where the toner amount and the toner charge amount of the reference image respectively exceed predetermined values, it is determined that the toner amount and the toner charge amount before the bare surface measurement are not appropriate, and a cleaning condition for cleaning performed by the cleaning brush 23 is changed so that the surface of the intermediate transfer belt 8 can be cleaned in an appropriate manner. Examples of cleaning conditions include the rotation rate of the cleaning brush 23, the cleaning voltage that is applied to the cleaning brush 23 via the collection roller 25, the pre-cleaning voltage that is applied to the pre-brush 41, the primary transfer voltage that is applied between the photosensitive drums 1a to 1d and the intermediate transfer belt 8, etc.

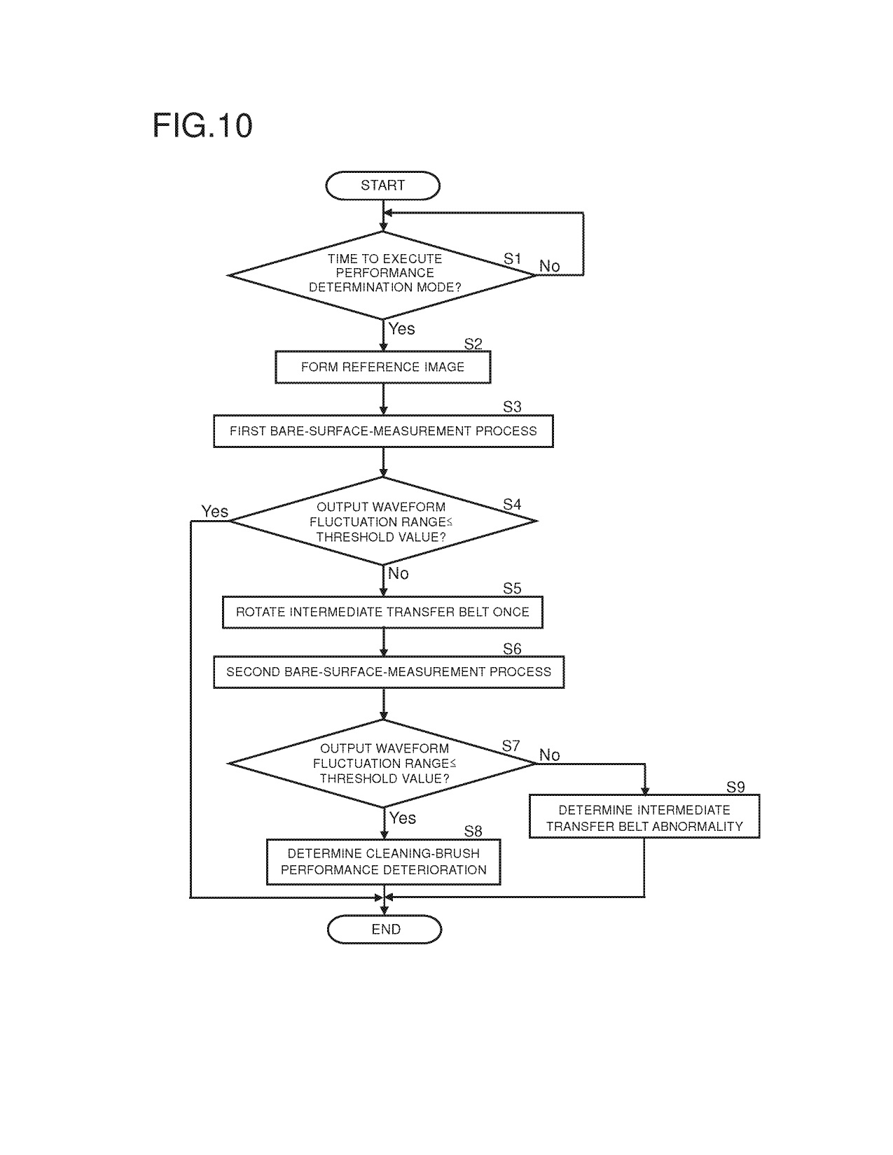

FIG. 10 is a flowchart showing an example of controlling the cleaning performance determination mode executed in the image forming apparatus 100. With reference to FIGS. 1 to 9, as necessary, and following the steps shown in FIG. 10, the procedure of executing the cleaning performance determination mode will be described.

First, the control portion 90 determines whether it is time to execute the cleaning performance determination mode (step S1). The execution timing of the cleaning performance determination mode is determined, for example, based on whether the cumulative number of sheets printed since the previous cleaning performance determination mode has reached a predetermined number.

In a case where it is time to execute the cleaning performance determination mode (Yes in step S1), first, a reference image is formed on the intermediate transfer belt 8 (step S2). This reference image may be the same image as the reference images C1 to K1 (solid images) formed during a first adjustment process in calibration, or may be a solid image printed with a different toner amount than the reference images C1 to K1.

Subsequently, the intermediate transfer belt 8 is rotated once for the cleaning brush 23 to collect the reference image, and then the first bare-surface-measurement process is executed (step S3). The control portion 90 determines whether a fluctuation range of the output waveform is equal to or less than a threshold value (step S4).

In a case where, as shown in FIG. 8, peaks appear due to the influence of residual toner, and the fluctuation range of the output waveform exceeds the threshold value (No in step S4), the control portion 90 drives the intermediate transfer belt 8 to rotate once more (step S5). Then, a second bare-surface-measurement process is executed (step S6), and it is determined whether the fluctuation range of the output waveform is equal to or less than the threshold value (step S7).

As shown in FIG. 9, in a case where the fluctuation range of the output waveform is equal to or less than the threshold value (Yes in Step S7), that is, in a case where the surface condition of the intermediate transfer belt 8 has returned to normal after the additional rotation, the control portion 90 determines that the cleaning performance of the cleaning brush 23 has deteriorated (Step S8). Further, the control portion 90 issues a notification regarding the deterioration of the cleaning performance of the cleaning brush 23. Specifically, on the liquid crystal display portion 71 (see FIG. 4), a message is displayed prompting replacement of the cleaning brush 23.

In a case where the fluctuation range of the output waveform exceeds the threshold value in step S7 (No in step S7), that is, in a case where the surface condition of the intermediate transfer belt 8 cannot be returned to normal even by the additional rotation of the intermediate transfer belt 8, the control portion 90 determines that an abnormality, such as scratches, irregularities, and the like, has occurred on the intermediate transfer belt 8 (step S9). Further, the control portion 90 issues a notification regarding the abnormality of the intermediate transfer belt 8. Specifically, on the liquid crystal display portion 71 (see FIG. 4), a message is displayed prompting replacement of the intermediate transfer belt 8.

On the other hand, in a case where, in step S4, the fluctuation range of the output waveform is equal to or less than the threshold value (Yes in step S4), it is determined, without rotating the intermediate transfer belt 8 once more, that the cleaning performance of the cleaning brush 23 is normal, and the process is finished.

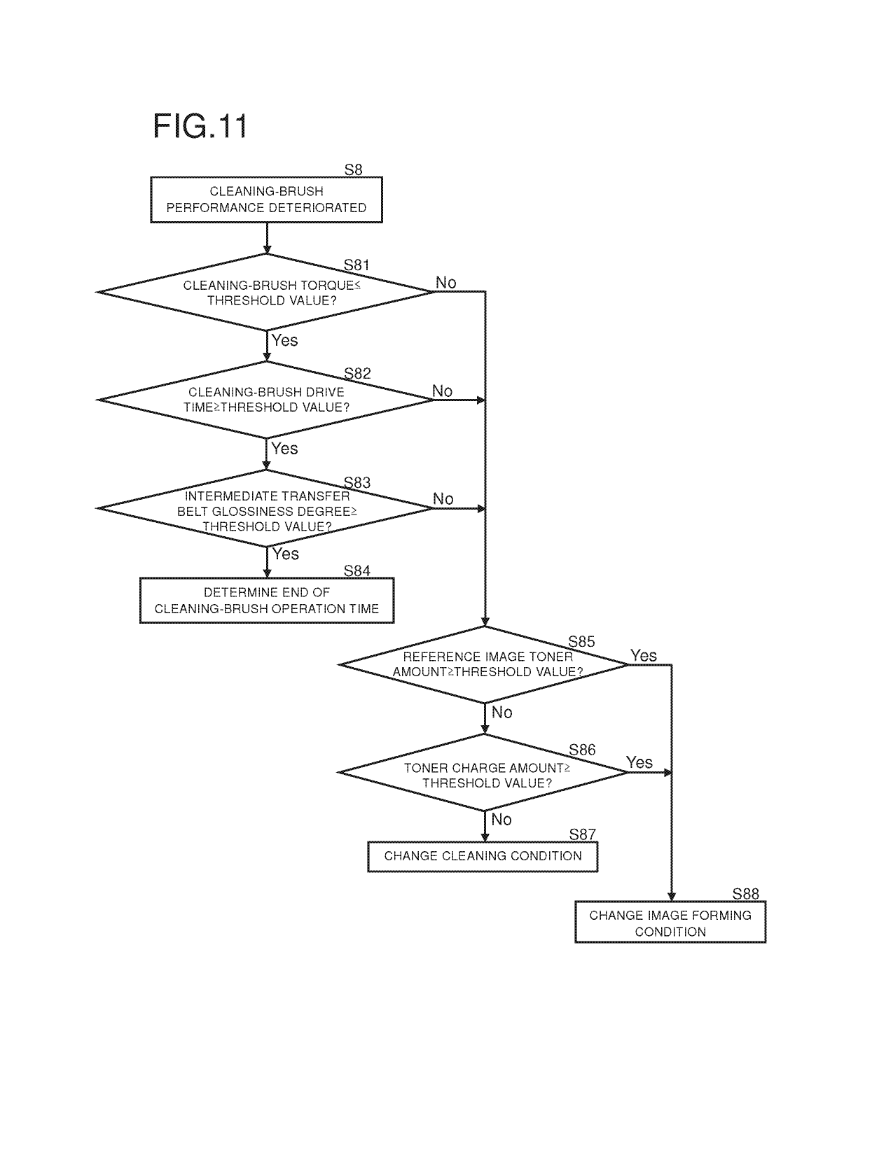

FIG. 11 is a flowchart showing an example of controlling operational-life determination for the cleaning brush 23 and changing of a cleaning condition when it is determined that the cleaning performance of the cleaning brush 23 has deteriorated.

In a case where, in FIG. 10, it is determined that the cleaning performance of the cleaning brush 23 has deteriorated (step S8), the control portion 90 determines whether the drive torque of the cleaning brush 23 is equal to or less than a threshold value (step S81). A major factor contributing to the deterioration in the cleaning performance of the cleaning brush 23 is the deterioration of the cleaning brush 23 itself, in particular, outer diameter variation caused bristle leaning of the cleaning brush 23 or the like. If the outside diameter of the cleaning brush 23 becomes small, the drive torque of the cleaning brush 23 becomes small. Thus, the drive torque of the cleaning brush 23 serves as a cleaning performance degradation index.

When the driving torque of the cleaning brush 23 is equal to or less than the threshold value (Yes in step S81), the control portion 90 determines whether the drive time of the cleaning brush 23 is equal to or more than a threshold value (Step S82). As the drive time of the cleaning brush 23 increases, the cleaning brush 23 itself becomes increasingly deteriorated. Thus, the drive time of the cleaning brush 23 serves as an index of the degree of decline in cleaning performance.

In a case where the drive time of the cleaning brush 23 is equal to or more than the threshold value (Yes in step S82), the control portion 90 determines whether the glossiness degree of the intermediate transfer belt 8 is equal to or less than a threshold value (Step S83). The surface properties (surface roughness) of the intermediate transfer belt 8 affect the cleaning performance of the cleaning brush 23. More specifically, as the intermediate transfer belt 8 further deteriorates and its surface roughness increases, the cleaning performance of the cleaning brush 23 declines. The surface roughness of the intermediate transfer belt 8 correlates with the glossiness degree of the intermediate transfer belt 8 calculated from a detection result of the image density sensor 50.

Thus, the glossiness degree of the intermediate transfer belt 8 serves as an index of the degree of decline in cleaning performance. Specifically, in a case where the cleaning performance has declined despite that the glossiness degree of the intermediate transfer belt 8 is high, it can be determined that the cleaning performance of cleaning brush 23 itself has deteriorated.

In a case where the glossiness degree of the intermediate transfer belt 8 is equal to or more than the threshold value (Yes in step S83), the control portion 90 determines that the cleaning brush 23 has reached the end of its operational life (expiration of its useful service period) (Step S84). The control portion 90 comprehensively determines the operational life of the cleaning brush 23 based on the drive torque and the drive time of the cleaning brush 23 and the surface properties (glossiness degree) of the intermediate transfer belt 8.

In a case where the driving torque of the cleaning brush 23 exceeds the threshold value (No in Step S81), the drive time of the cleaning brush 23 is less than the threshold value (No in step S82), or the glossiness degree of the intermediate transfer belt 8 is less than the threshold value (No in step S83), the control portion 90 determines that the cleaning brush 23 has not reached the end of its operational life, and confirms the condition of the image forming apparatus 100.

The control portion 90 determines whether the toner amount of the reference image used for the cleaning performance determination mode is equal to or more than a threshold value (step S85). This is because, in a case where the toner amount is more than a predetermined value, there may arise a case where the reference image cannot be completely collected by the cleaning brush 23. The toner amount of the reference image can be calculated based on a detection result of the image density sensor 50.

In a case where the toner amount of the reference image is less than the threshold value (No in step S85), the control portion 90 determines whether the toner charge amount is equal to or more than a threshold value (Step S86). This is because, when the toner charge amount is more than a predetermined value, adhesion force with respect to the intermediate transfer belt 8 increases, and there may arise a case where the reference image cannot be completely collected by the cleaning brush 23. The toner charge amount can be estimated from a reflection density of the reference image detected by the image density sensor 50, and a development current flowing between each of the photosensitive drums 1a to 1d and their corresponding developing roller 31.

In a case where the toner charge amount is less than the threshold value (No in step S86), the control portion 90 determines that the reference image has been formed normally and that the cleaning brush 23 has not reached the end of its operational life, and changes a cleaning condition (Step S87). Specifically, the cleaning voltage that is applied to the cleaning brush 23 via the collection roller 25 from the belt-cleaning voltage power supply 55, the rotation rate of the cleaning brush 23, the primary transfer voltage that is applied between the photosensitive drums 1a to 1dand the intermediate transfer belt 8, or the pre-cleaning voltage that is applied to the pre-brush 41 from the pre-brush voltage power supply 56 is changed.

In a case where the toner amount of the reference image is equal to or more than the threshold value (Yes in step S85) or the toner charge amount is equal to or more than the threshold value (Yes in step S86), the control portion 90 determines that the reference image has not been normally formed, and changes an image forming condition (step S88). Specifically, the development voltage that is applied to the developing roller 31 of each of the developing devices 3a to 3d is changed.

According to the control example shown in FIGS. 10 and 11, by executing the cleaning performance determination mode, it is possible to make an accurate determination regarding deterioration in cleaning performance of the cleaning brush 23 or abnormal surface condition of the intermediate transfer belt 8.

Moreover, in a case where the cleaning performance of the cleaning brush 23 has deteriorated, the drive torque and the drive time of the cleaning brush 23 and the glossiness degree of the intermediate transfer belt 8 are measured. This enables accurate determination of whether the cleaning brush 23 has reached the end of its operational life.

Furthermore, in a case where it has been determined that the cleaning brush 23 has not reached the end of its operational life yet although the deterioration in cleaning performance of the cleaning brush 23 has been detected, a factor of the deterioration is identified, and in accordance with the identified deterioration factor, a cleaning condition or an image forming condition is changed. Thereby, it is possible to effectively remove residual toner remaining on the intermediate transfer belt 8 due to the deteriorated cleaning performance of the cleaning brush 23.

The present disclosure may be implemented in any manner other than specifically described above as embodiments, and allows for various modifications within the scope of the present disclosure. For example, in the foregoing embodiments, a tandem-type color printer as shown in FIG. 1 has been described by way of example as the image forming apparatus 100; however, it should be understood that the present disclosure is not limited thereto and may be applied to various types of image forming apparatuses employing an intermediate transfer method provided with a cleaning brush, such as color copiers and color multifunction peripherals.

The present disclosure is usable in an image forming apparatus that uses a cleaning brush to remove residual toner remaining on an intermediate transfer belt. By using the present disclosure, it is possible to provide an image forming apparatus capable of detecting performance deterioration of a cleaning brush as well as detecting damage and contamination of an intermediate transfer belt.

1. An image forming apparatus, comprising:
an image carrying member that includes a photosensitive layer formed on a surface thereof;
a charging device that charges the surface of the image carrying member;
an exposure device that exposes, to light, the surface of the image carrying member having been charged by the charging device, thereby forming an electrostatic latent image with attenuated charge;
a developing device that includes a developer carrying member carrying a developer including toner, and that develops the electrostatic latent image having been formed on the image carrying member into a toner image;
an intermediate transfer belt that has an endless shape and that rotates in contact with the image carrying member, thereby allowing the toner image formed on the image carrying member to be primarily transferred thereto;
a cleaning brush that removes toner remaining on the intermediate transfer belt;
an image density sensor that detects density of the toner image having been primarily transferred onto the intermediate transfer belt; and
a control portion that is capable of executing a cleaning performance determination mode for determining cleaning performance of the cleaning brush,
wherein
the cleaning performance determination mode includes:
a reference image formation process of forming a reference image on the intermediate transfer belt; and
a first bare-surface-measurement process of detecting a reference-image formation area, using the image density sensor, after the intermediate transfer belt has rotated once, and
when a fluctuation range of an output waveform of the image density sensor in the first bare-surface-measurement process is equal to or less than a threshold value, it is determined that the cleaning performance of the cleaning brush is normal.

2. The image forming apparatus according to claim 1,
wherein
in a case where the fluctuation range of the output waveform of the image density sensor in the first bare-surface-measurement process exceeds the threshold value, the control portion executes a second bare-surface-measurement process of detecting the reference-image formation area using the image density sensor after causing the intermediate transfer belt to rotate once more, and
in a case where a fluctuation range of an output waveform of the image density sensor in the second bare-surface-measurement process is equal to or less than the threshold value, it is determined that the cleaning performance of the cleaning brush has deteriorated.

3. The image forming apparatus according to claim 2, further comprising a notification portion capable of issuing notifications regarding conditions of various portions of the image forming apparatus including the cleaning brush,
wherein
in a case where the fluctuation range of the output waveform of the image density sensor in the second bare-surface-measurement process is equal to or less than the threshold value, the control portion, using the notification portion, issues a notification regarding deteriorated performance of the cleaning brush.

4. The image forming apparatus according to claim 2,
wherein
in a case where the fluctuation range of the output waveform of the image density sensor in the second bare-surface-measurement process exceeds the threshold value, the control portion determines that a surface condition of the intermediate transfer belt is abnormal.

5. The image forming apparatus according to claim 4, further comprising a notification portion capable of issuing notifications regarding conditions of various portions of the image forming apparatus including the intermediate transfer belt,
wherein
in a case where the fluctuation range of the output waveform of the image density sensor in the second bare-surface-measurement process exceeds the threshold value, the control portion, using the notification portion, issues a notification prompting replacement of the intermediate transfer belt.

6. The image forming apparatus according to claim 1,
wherein
in a case where the fluctuation range of the output waveform of the image density sensor in the second bare-surface-measurement process is equal to or less than the threshold value, the control portion detects a drive torque of the cleaning brush, a drive time of the cleaning brush, and a surface glossiness degree of the intermediate transfer belt, and
when the drive torque is equal to or less than a predetermined value, the drive time is equal to or more than a predetermined value, and the surface glossiness degree is equal to or more than a predetermined value, it is determined that the cleaning brush has reached an end of operational life thereof.

7. The image forming apparatus according to claim 6,
wherein
the control portion detects a toner amount and a toner charge amount of the reference image when at least one of the following cases is satisfied: a case where the drive torque exceeds the predetermined value; a case where the drive time is less than the predetermined value; or a case where the surface glossiness degree is less than the predetermined value, and
when the toner amount is less than a predetermined value and the toner charge amount is less than a predetermined value, a cleaning condition for cleaning performed by the cleaning brush is changed.

8. The image forming apparatus according to claim 7, further comprising:
a collection roller that collects toner and other substances adhered on the cleaning brush; and
a cleaning voltage power supply that applies, to the collection roller, a cleaning voltage having an opposite polarity to the toner,
wherein
the control portion changes, as the cleaning condition, at least one of the following: rotation rate of the cleaning brush, the cleaning voltage, or a primary transfer voltage applied between the image carrying member and the intermediate transfer belt.

9. The image forming apparatus according to claim 7, further comprising:
a pre-brush that is disposed upstream of the cleaning brush with respect to a movement direction of the intermediate transfer belt, and that controls a charge amount of the toner on the intermediate transfer belt; and
a pre-cleaning voltage power supply that applies, to the pre-brush, a pre-cleaning voltage having a same polarity as the toner,
wherein
the control portion changes the pre-cleaning voltage as the cleaning condition.

10. The image forming apparatus according to claim 7,
wherein
the control portion changes an image forming condition when the toner amount is equal to or more than the predetermined value and the toner charge amount is equal to or more than the predetermined value.
